(19) United States
(12) Patent Application Publication
(10) Pub. No.: US 2007/0204574 A1
(43) Pub. Date: Sep. 6, 2007

(54) Planar filter frame with corner latch and method of folding

(75) Inventor: Roger L. Workman, St. Petersburg, FL (US)

Correspondence Address: NIXON PEABODY, LLP, 401 9TH STREET, NW, SUITE 900, WASHINGTON, DC, 20004-2128, US

(73) Assignee: FLANDERS FILTERS, INC., St. Petersburg, FL (US)

(21) Appl. No.: 11/367,713

(22) Filed: Mar. 6, 2006

(51) Int. Cl. B01D 46/00

(52) U.S. Cl. 55/495; 55/502

(57) ABSTRACT

A planar frame of cardboard or other suitable sheet material with an interlocking corner construction. The corner connection provided in this invention securely locks the corner in place at low manufacturing cost. It can be integrated easily into the filter frame assembly process without addition additional steps. While the locking mechanism is secure to hold the frame in place for transport, during manufacturing, and for final filter usage, it is removable to allow for the frame to be unfolded and reassembled if necessary during manufacturing, e.g. to insert filter media. Preferably, after inserting filer media, the tabs hold the filter and frame in an assembled configuration until the frame can be sealed with adhesive. In a preferred embodiment, the frame comprises three simple, rectangular tabs. The first tab is attached to the first frame leg and simply slides between the outer and inner frame parts of the second frame leg. The second tab, which is small in width (approx. ⅓ to ½ of the width of the frame leg width in plane of the filter medium) and extremely small in depth (approx. less than 1 mm), is attached to the first frame leg and inserted into a small slit in the adjacent second frame leg during assembly. Due to its small size, this tab locks the corner in place but barely protrudes to the outside of the frame. The corner can be disassembled without destroying the tab by pulling the second leg to the outside. The third tab holding the corner in place is located at the second frame leg at the outside border of the scored blank. This tab is inserted into a fitted opening located in the inside fold of the first frame leg. This tab holds the frame corner in place but can be popped out of its fitted opening by pulling the first frame leg to the outside with a specific force. Alternative embodiments may contain the first and second tab only, or the first and third tab only.

### BACKGROUND OF THE INVENTION

1. Field of the Invention

The present invention relates generally to planar filter frames and, more particularly, to planar frames of cardboard, paperboard or other suitable sheet material with an interlocking corner construction.

2. Description of the Prior Art

Generally, prior art in the field of planar filter frames of cardboard with latching corner constructions goes back to the 1970s and relates to three different types of mechanism:

a) frames where adjacent frame legs are connected in the corners by tabs or reinforcements of additional material by means of adhesive or staples,
b) frames of a single scored and cut cardboard blank, where each corner is formed by folding scored and cut extensions of the adjacent sides onto each other and secure them by means of adhesive and
c) frames of a single scored and cut cardboard blank, where each corner is formed by folding scored and cut extension tabs of one frame leg onto the adjacent leg, or sliding the tabs into a folding or slit of the adjacent leg.

Most relevant prior art to the present invention relates to types b) and c) of filter frames.

A pioneering example of a sturdy corner construction for planar filter frames, yet of type a), was disclosed in U.S. Pat. No. 3,970,440 issued Jul. 20, 1976, to Copenhefer, et al., assigned to United States Gypsum Company, for Compact Air Filter. This planar air filter comprises a frame formed of an integral suitable cut and scored blank of paperboard. The frame members may be connected together by glue flaps hingedly connected to one frame member and adhesively affixed to an adjacent member. More relevant prior art of frame types b) and c) subsequent to this patent is cited below with brief abstract statements summarizing the main points for each reference:

U.S. Pat. No. 3,992,173 issued Nov. 16, 1976, to Wharton, et al., assigned to Korhumel Industries, Inc. (Chicago, Ill.), for Air filter and method of making same, describes an air filter with a unitary frame that has a perforated panel supportingly engaging one face of the layer with folded up narrow panels along the edges of the layer, narrow retainer panels overlying the margins of the opposite face of the layer from the perforated panel, and each of the retainer panels being provided with spaced extensions which overlap adjacent the corners of the layer and are secured together as by means of adhesive, there also being anchoring adhesive securing two of the retainer panels to the filter layer. The overlapping extensions are perforated.

U.S. Pat. No. 4,086,071 issued Apr. 25, 1978, to Champlin, assigned to Packaging Corporation of America (Evanston, Ill.), for Air filter assembly, describes an air filter assembly, which comprises a multisided air filter panel and a multisided supporting frame therefor. The frame is of unitary construction and includes a foraminous center section, and a marginal section delimiting the center section. The center and marginal sections are in supporting engagement with one surface of the filter panel. The frame is provided with a plurality of peripheral sections which are foldably connected to the marginal section and cooperate with one another to delimit the center and marginal sections. Each peripheral section includes foldably connected first and second flange segments which are disposed in substantially face-to-face fold back relation. The first flange segment is foldably connected to a portion of the marginal section and extends angularly inwardly therefrom and forms an acute angle with the portion of the marginal section to which it is attached. A third segment is foldably connected to the second flange segment and extends angularly therefrom. Tabs are foldably connected to the ends of the second flange segments of alternate peripheral sections and when the frame is set up in assembled relation the tabs become automatically aligned with and inserted into adjacent pockets formed by the adjacent first and second flange segments of the adjacent peripheral section. The construction of the frame enables the filter assembly to assume a collapsed state so that a plurality of such assemblies can form a compact bundle for shipping and/or storage.

U.S. Pat. No. 4,105,423 issued Aug. 8, 1978, to Latakas, et al., assigned to United States Gypsum Company, for Compact air filter with tubular frame, includes a frame formed of an integral suitable cut and scored blank of paperboard, with planar frame members and flared frame members disposed at an angle of less than 180 degree permitting a plurality of completed filters to nest within each other. The end portions of the flared frame members may be connected together by several means, including glue flaps hingedly connected to one frame member and adhesively affixed to an adjacent member.

U.S. Pat. No. 4,323,379 issued Apr. 6, 1982, to Shearin, assigned to Facet Enterprises, Inc. (Tulsa, Okla.), for Air filter panel, includes a frame having an axially extending frame element, the frame element being folded transversely to form frame sidewalls, the ends of the folded frame element being fastened together, the improvement comprising an improved frame end fastening means, the means comprising a tab connected at a fixed end thereof to the sidewall of the support frame adjacent one end of the frame element, the tab having a neck portion at the fixed end and a head portion adjacent a free end thereof, the head portion being connected along a portion of a following edge thereof to the neck portion, the remaining unconnected portion of the following edge providing a flange portion, and a slot in the sidewall adjacent the end of the frame element opposing the tabbed end, the slot being adapted to receive the head of the tab, whereby when the free end of the tab is inserted in the slot, the ends of the folded frame are held together by the tab, and the flange portion of the following edge of the head abuts against an edge of the slot to restrain the tab from being removed from the slot.

U.S. Pat. No. 4,372,763 issued Feb. 8, 1983, to Champlin, et al., assigned to Packaging Corporation of America (Evanston, Ill.), for Air filter assembly, comprises a frame of foldable sheet material with a marginal section delimiting the center section; and a plurality of elongated peripheral sections arranged in alternate pairs and foldably connected to and co-acting with the marginal section and with each other to form a hollow verge encompassing the filter panel periphery when the frame is in the second mode. The peripheral sections form a substantially flat multiply flange overlapping and compressing the filter panel periphery when the frame is in the first mode. A first pair of alternate peripheral sections have the opposite end portions thereof overlying corresponding end portions of a second pair of alternate peripheral sections when the frame is in the first mode. When the frame is adjusted from the first mode to the second mode, the overlapped end portions of the second pair of alternate peripheral sections will abuttingly engage at an angle the corresponding end portions of the first pair of alternate peripheral sections and restrain movement of the frame from the second mode to the first mode.

U.S. Pat. No. 4,561,587 issued Dec. 31, 1985, and U.S. Pat. No. 4,570,844 issued Feb. 18, 1986, to Wysocki, assigned to Champion International Corporation (Stamford, Conn.), for Frame made from paperboard and having lockable corners, and Paperboard frame with lockable corners, respectively, describe a frame from a one-piece paperboard blank which is formed in a collapsed shipment and storage blank configuration. The collapsed frame can be manually expanded for use. The corners of the expanded frame are locked by locking tabs and locking slots or overlapping tabs to hold the frame in its expanded state.

U.S. Pat. No. 5,655,825 issued Aug. 12, 1997, to Anoszko, assigned to Research Products Corporation (Madison, Wis.), for Latch arrangement for air filter housing describes a one-piece filter frame with a pair side walls and a pair of end walls. Each of either of the sidewalls or end walls is provided with a tab-type latch which includes a button undercut at least a peripheral portion thereof. Each of the other sidewalls or end walls has an opening formed therethrough. The opening is defined by a wall shaped in accordance with and frictionally surrounding the undercut button in a snap-fit to hold the sidewalls to the end walls in an assembled state.

U.S. Pat. No. 6,033,454 issued Mar. 7, 2000, to Hoeffken, assigned to AAF International (Louisville, Ky.), Inc., for Air filter assembly, includes a rectangular frame with a pair of parallel side rails and a pair of parallel end rails along outer edges of plane-defining surfaces, the rails flaring outboardly at an obtuse angle from the plane when the frame is unconfined, one of the rails at each corner of the rectangular frame being provided with tabs, and the other, contiguous of the rails at the corner having an open end into which the tab extends. The tabs have an angled outer surface and are of a length compared with the height of the open end to be held against movement clear of the open end in every position of the rails when the frame is assembled, to limit the outward flare of the rails and to ensure that the corners of the rails are substantially closed in every position of the rails.

U.S. Patent Application No. 20040148915 published Aug. 5, 2004, to Lipner, assigned to The True Blue Company (LaPort, Ind.), for Foldable filter frame comprises a foldable filter frame including four edge elements. Each edge element has a double-walled construction and is foldable into a position in which a first leg of the respective edge element is generally perpendicular to a second leg of the edge element. An end of at least one of the edge elements that defines a corner of the frame supports a foldable tab that is receivable in a complementary slot in an end of the other edge element defining the respective corner of the frame with the tab being arranged in an inner space between the double-walls of the edge element.

Some prior art (U.S. Pat. No. 3,970,440, U.S. Pat. No. 3,992,173, U.S. Pat. No. 4,372,763) includes corner tabs that need to be adhesively attached to at least one frame member to stay in place and hold the corner together. In these cases, the frame does not stay in its assembled shape until the adhesive is dried. The application of the adhesive adds additional cost to the manufacturing process. The adhesive increases material cost. This corner mechanism also requires additional processing means to keep the corners in place during transport from one assembly stage to the next and an additional processing step to apply and let dry the adhesive.

U.S. Pat. No. 5,655,825 requires a snap button to keep the corner in place.

Other prior art (U.S. Pat. No. 4,086,071, U.S. Pat. No. 4,323,379, U.S. Pat. No. 4,561,587, U.S. Pat. No. 4,570,844, U.S. Pat. No. 6,033,454, Patent Application No. 2004148915) covers frame corner constructions that include tabs attached and parallel to one frame member that are slid into or through the adjacent frame member. While some of these tabs may hold the corner together without applying adhesive, these tabs are complex in shape, therefore difficult to manufacture and assemble, will hold the corner in place permanently and not allow the corner to be opened without destroying the tab connection.

Thus, there remains a need for a corner connection that securely locks the corner in place at low manufacturing cost. The locking mechanism should be secure to hold the frame in place during assembly after inserting filter media and prior to sealing the frame.

### SUMMARY OF THE INVENTION

The present invention is directed to a planar filter frame of cardboard, paperboard, or other suitable sheet material with an interlocking corner construction. It provides a stable, locked corner construction that can be easily integrated into filter frame assembly process without adding additional steps. The corner connection provided is stable, yet removable. It allows for the frame to be unfolded and reassembled if necessary during manufacturing. Further it holds its shape after inserting a filter media until the frame is sealed with glue or other adhesive.

In a preferred embodiment, each frame corner comprises three simple, rectangular tabs. The first tab is attached to the first frame leg and simply slides between the outer and inner frame parts of the second frame leg. The second tab, which is small in width (approx. ⅓ to ½ of the width of the frame leg width in plane of the filter medium) and extremely small in depth (approx. less than 1 mm), is attached to the first frame leg at the very outside panel of the scored cardboard blank in direction of the frame leg. This tab is inserted into a small slit between the bottom and the side panel of the adjacent second frame leg during assembly. Due to its small size, this tab locks the corner in place but barely protrudes to the outside of the frame. The corner can be disassembled without destroying the tab by pulling the adjacent second leg to the outside with a specific force.

The third tab holding the corner in place is located at the second frame leg at the outside border of the scored blank. This tab is inserted into a fitted opening located in the inside fold of the first frame leg. This tab holds the frame corner in place but can be popped out of its fitted opening by pulling the first frame leg to the outside with a specific force.

Alternative embodiments may contain the first and second tab only, or the first and third tab only.

The present invention is further directed to a method of folding a foldable filter frame.

These and other aspects of the present invention will become apparent to those skilled in the art after a reading of the following description of a preferred embodiment when considered with the drawings.

### BRIEF DESCRIPTION OF THE DRAWINGS

FIG. 1 is a perspective illustration of one corner of the planar, scored and cut cardboard blank before assembling the filter frame, in a first preferred embodiment.

FIG. 2 shows how the corner is assembled from the cardboard blank of FIG. 1 when manufacturing the frame.

FIG. 3 shows a preferred embodiment of the invention with a first and second tab only.

FIG. 4 shows a preferred embodiment of the invention with a first and third tab only.

### DETAILED DESCRIPTION OF THE PREFERRED EMBODIMENTS

In the following description, like reference characters designate like or corresponding parts throughout the several views. Also in the following description, it is to be understood that such terms as “forward,” “rearward,” “front,” “back,” “right,” “left,” “upwardly,” “downwardly,” “horizontal,” “vertical,” and the like are words of convenience and are not to be construed as limiting terms.

Referring now to the drawings in general, the illustrations are for the purpose of describing a preferred embodiment of the invention and are not intended to limit the invention thereto.

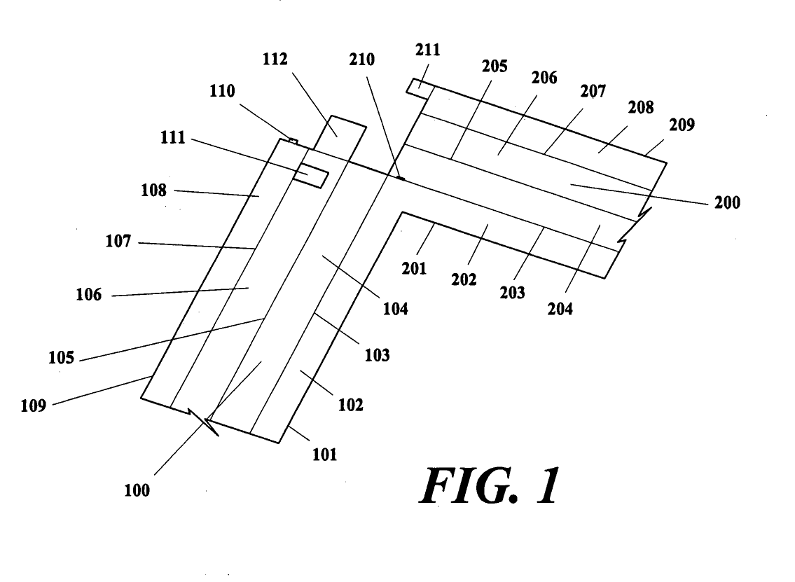

FIG. 1 shows a perspective illustration of a filter frame corner in a first preferred embodiment as part of a filter frame from a scored and cut card board or other suitable material in flat, unassembled mode. Preferably, the frame has four corners and is square or rectangular in shape. The present invention permits the frame to be folded into a near-assembly position with a filter media such that the folded frame stays in place via tabs until the frame can be sealed with glue or other adhesive. The corner represents a connection between a first frame leg 100 and a second frame leg 200, which is perpendicular to the first frame leg 100. The first leg is delimited by its inner edge in direction of the frame leg, 101, and its outer edge in direction of the frame leg, 109. The first frame leg consists of four portions:

1) a first inner portion, 102, which constitutes the bottom portion of the frame in plane with the filter medium panel in assembled mode,
2) a second portion, 103, which is adjacent to the first portion and constitutes the outside portion of the frame perpendicular or at an obtuse angle to the filter medium panel in assembled mode,
3) a third portion, 104, which is adjacent to the second portion and constitutes the inside portion of the frame perpendicular or at an obtuse angle to the filter medium panel in assembled mode, and
4) a forth portion, 105, which is adjacent to the third portion and constitutes the inside portion of the frame in plane with the filter medium panel in assembled mode.

The score and fold line between the first and the second portion of the first frame leg is denoted as 103. The first and second leg portions are folded perpendicular to each other or at an obtuse angle in assembled mode. The score and fold line between the second and the third portion of the first frame leg is denoted as 105. The third leg portion is completely folded back to the inside of the filter frame onto the second leg portion to form an integral outside edge of the filter frame perpendicular or at an obtuse angle to the plane of the filter medium panel and the first and forth leg portion of the frame. The score and fold line between the third and the forth portion of the first frame leg is denoted as 107. The forth leg portion is folded perpendicular or at an obtuse angle to the third leg portion, so that it is essentially parallel to the first frame leg portion and clampingly engages the filter medium panel therewith.

The second leg is delimited by its inner edge in direction of the frame leg, 201, and its outer edge in direction of the frame leg, 209. Same as the first leg, the second frame leg consists of four portions:

1) a first inner portion, 202, which constitutes the bottom portion of the frame in plane with the filter medium panel in assembled mode,
2) a second portion, 203, which is adjacent to the first portion and constitutes the outside portion of the frame perpendicular or at an obtuse angle to the filter medium panel in assembled mode,
3) a third portion, 204, which is adjacent to the second portion and constitutes the inside portion of the frame perpendicular or at an obtuse angle to the filter medium panel in assembled mode, and
4) a forth portion, 205, which is adjacent to the third portion and constitutes the inside portion of the frame in plane with the filter medium panel in assembled mode.

The score and fold line between the first and the second portion of the second frame leg is denoted as 203. The first and second leg portions are folded perpendicular to each other or at an obtuse angle in assembled mode. The score and fold line between the second and the third portion of the second frame leg is denoted as 205. The third leg portion is completely folded back to the inside of the filter frame onto the second leg portion to form an integral outside edge of the filter frame perpendicular or at an obtuse angle to the plane of the filter medium panel and the first and forth leg portion of the frame. The score and fold line between the third and the forth portion of the second frame leg is denoted as 207. The forth leg portion is folded perpendicular or at an obtuse angle to the third leg portion, so that it is essentially parallel to the first frame leg portion and clampingly engages the filter medium panel therewith.

The first frame leg is provided with a tab at its third portion towards the corner, 112. This tab will slide between the second and third portion of the second leg during frame assembly. Preferably, this tab is straight. Alternatively, this tab may be at an angle to the first frame leg.

At its end towards the corner, the outside, forth portion of the first frame leg has a very small tab, 110. During frame assembly, this tab is inserted in a corresponding small slit, 210, provided at the score line 203 of the second frame leg.

At its end towards the corner, the outside, forth portion of the second frame leg has an elongated tab, 211. During frame assembly, this tab is popped into a corresponding opening, 111, provided in the third portion of the first frame leg.

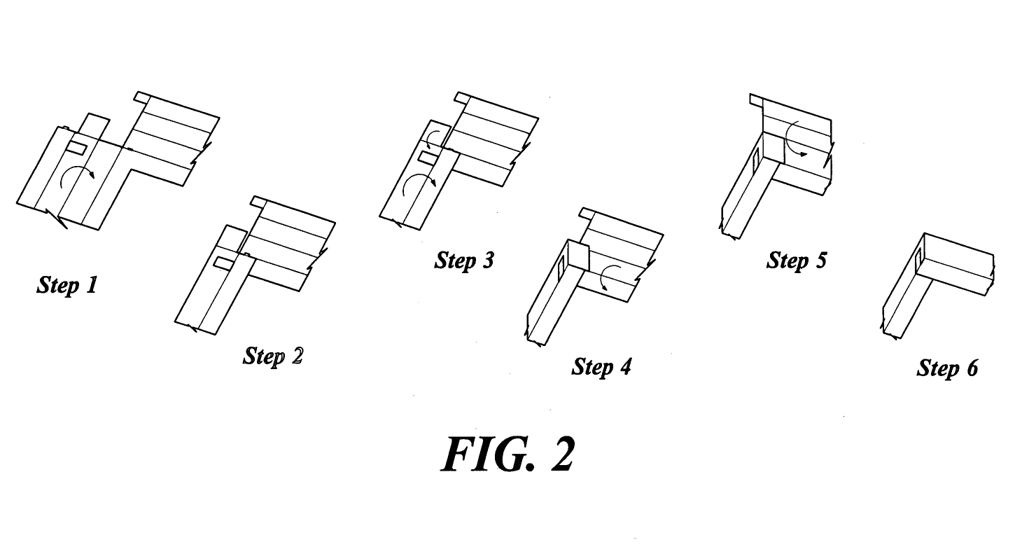

FIG. 2 shows a detailed assembly process of the frame corner provided in FIG. 1. First, the third and forth portion of the first frame leg are folded at a 180 degree angle onto the first and second portion of the first frame leg, resulting in the structure shown in Step 2. The tab 110 is inserted in the slit 210, which results in the structure shown in Step 3. At the same time, the second and third portions of the first leg are folded up to form a 90 degree or obtuse angle with the first and forth portion of the first leg. In addition, the tab 112 is folded up to form a 90 degree or obtuse angle with the second leg portion of the first frame leg. This results in the structure shown in Step 4. The second, third and forth leg portion of the second frame leg are folded at 90 degree or an obtuse angle to the first leg portion of the second frame leg, which results in the structure shown in Step 5. Finally, the third leg portion of the second frame leg is folded back onto the second frame portion of the second frame leg, and the forth leg portion of the second frame leg is folded back onto the first portion of the second frame leg, forcing the tab 211 into its corresponding opening 111 in the first frame leg.

While the locking mechanism is secure to hold the frame in place for transport, during manufacturing, and for final filter usage, it is removable to allow for the frame to be unfolded and reassembled if necessary during manufacturing, e.g. to insert filter media. Preferably, after inserting filer media, the tabs hold the filter and frame in an assembled configuration until the frame can be sealed with glue or other adhesive.

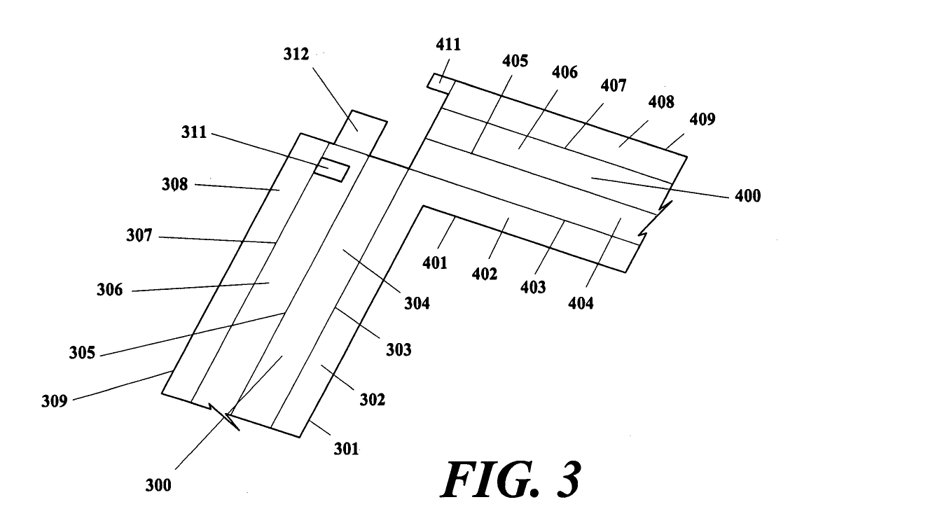

FIG. 3 shows a perspective illustration of a filter frame corner in a second preferred embodiment in flat, unassembled mode. The corner represents a connection between a first frame leg 300 and a second frame leg 400, which is perpendicular to the first frame leg 300. The first leg is delimited by its inner edge in direction of the frame leg, 301, and its outer edge in direction of the frame leg, 309. The first frame leg consists of four portions:

1) a first inner portion, 302, which constitutes the bottom portion of the frame in plane with the filter medium panel in assembled mode,
2) a second portion, 303, which is adjacent to the first portion and constitutes the outside portion of the frame perpendicular or at an obtuse angle to the filter medium panel in assembled mode,
3) a third portion, 304, which is adjacent to the second portion and constitutes the inside portion of the frame perpendicular or at an obtuse angle to the filter medium panel in assembled mode, and
4) a forth portion, 305, which is adjacent to the third portion and constitutes the inside portion of the frame in plane with the filter medium panel in assembled mode.

The score and fold line between the first and the second portion of the first frame leg is denoted as 303. The first and second leg portions are folded perpendicular to each other or at an obtuse angle in assembled mode. The score and fold line between the second and the third portion of the first frame leg is denoted as 305. The third leg portion is completely folded back to the inside of the filter frame onto the second leg portion to form an integral outside edge of the filter frame perpendicular or at an obtuse angle to the plane of the filter medium panel and the first and forth leg portion of the frame. The score and fold line between the third and the forth portion of the first frame leg is denoted as 307. The forth leg portion is folded perpendicular or at an obtuse angle to the third leg portion, so that it is essentially parallel to the first frame leg portion and clampingly engages the filter medium panel therewith.

The second leg is delimited by its inner edge in direction of the frame leg, 401, and its outer edge in direction of the frame leg, 409. Same as the first leg, the second frame leg consists of four portions:

1) a first inner portion, 402, which constitutes the bottom portion of the frame in plane with the filter medium panel in assembled mode,
2) a second portion, 403, which is adjacent to the first portion and constitutes the outside portion of the frame perpendicular or at an obtuse angle to the filter medium panel in assembled mode,
3) a third portion, 404, which is adjacent to the second portion and constitutes the inside portion of the frame perpendicular or at an obtuse angle to the filter medium panel in assembled mode, and
4) a forth portion, 405, which is adjacent to the third portion and constitutes the inside portion of the frame in plane with the filter medium panel in assembled mode.

The score and fold line between the first and the second portion of the second frame leg is denoted as 403. The first and second leg portions are folded perpendicular to each other or at an obtuse angle in assembled mode. The score and fold line between the second and the third portion of the second frame leg is denoted as 405. The third leg portion is completely folded back to the inside of the filter frame onto the second leg portion to form an integral outside edge of the filter frame perpendicular or at an obtuse angle to the plane of the filter medium panel and the first and forth leg portion of the frame. The score and fold line between the third and the forth portion of the second frame leg is denoted as 407. The forth leg portion is folded perpendicular or at an obtuse angle to the third leg portion, so that it is essentially parallel to the first frame leg portion and clampingly engages the filter medium panel therewith.

The first frame leg is provided with a tab at its third portion towards the corner, 312. This tab will slide between the second and third portion of the second leg during frame assembly. Preferably, this tab is straight. Alternatively, this tab may be at an angle to the first frame leg.

At its end towards the corner, the outside, forth portion of the second frame leg has an elongated tab, 411. During frame assembly, this tab is popped into a corresponding opening, 311, provided in the third portion of the first frame leg.

The assembly process of the second preferred embodiment of the invention is the same as the process for the first preferred embodiment of the invention, as described in FIG. 2.

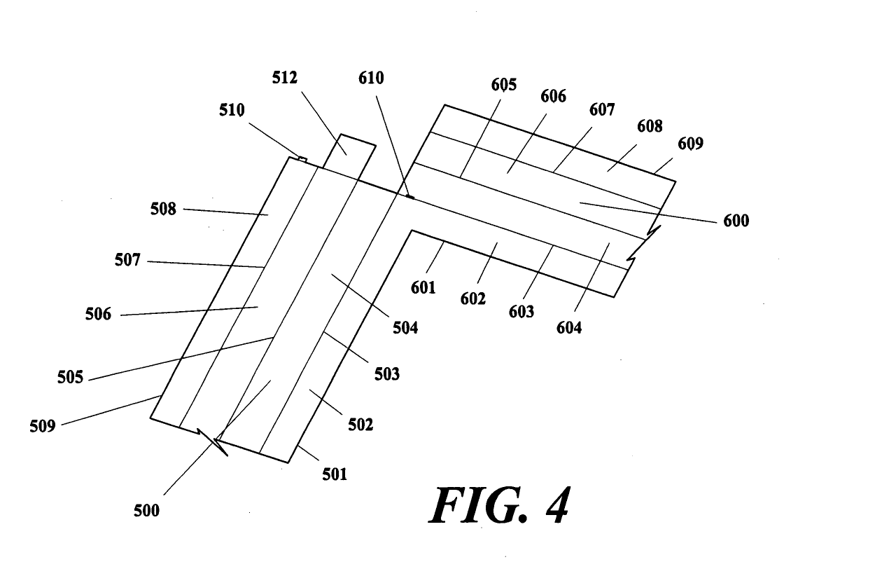

FIG. 4 shows a perspective illustration of a filter frame corner in a third preferred embodiment in flat, unassembled mode. The corner represents a connection between a first frame leg 500 and a second frame leg 600, which is perpendicular to the first frame leg 500. The first leg is delimited by its inner edge in direction of the frame leg, 501, and its outer edge in direction of the frame leg, 509. The first frame leg consists of four portions:

1) a first inner portion, 502, which constitutes the bottom portion of the frame in plane with the filter medium panel in assembled mode,
2) a second portion, 503, which is adjacent to the first portion and constitutes the outside portion of the frame perpendicular or at an obtuse angle to the filter medium panel in assembled mode,
3) a third portion, 504, which is adjacent to the second portion and constitutes the inside portion of the frame perpendicular or at an obtuse angle to the filter medium panel in assembled mode, and
4) a forth portion, 505, which is adjacent to the third portion and constitutes the inside portion of the frame in plane with the filter medium panel in assembled mode.

The score and fold line between the first and the second portion of the first frame leg is denoted as 503. The first and second leg portions are folded perpendicular to each other or at an obtuse angle in assembled mode. The score and fold line between the second and the third portion of the first frame leg is denoted as 505. The third leg portion is completely folded back to the inside of the filter frame onto the second leg portion to form an integral outside edge of the filter frame perpendicular or at an obtuse angle to the plane of the filter medium panel and the first and forth leg portion of the frame. The score and fold line between the third and the forth portion of the first frame leg is denoted as 507. The forth leg portion is folded perpendicular or at an obtuse angle to the third leg portion, so that it is essentially parallel to the first frame leg portion and clampingly engages the filter medium panel therewith.

The second leg is delimited by its inner edge in direction of the frame leg, 601, and its outer edge in direction of the frame leg, 609. Same as the first leg, the second frame leg consists of four portions:

1) a first inner portion, 602, which constitutes the bottom portion of the frame in plane with the filter medium panel in assembled mode,
2) a second portion, 603, which is adjacent to the first portion and constitutes the outside portion of the frame perpendicular or at an obtuse angle to the filter medium panel in assembled mode,
3) a third portion, 604, which is adjacent to the second portion and constitutes the inside portion of the frame perpendicular or at an obtuse angle to the filter medium panel in assembled mode, and
4) a forth portion, 605, which is adjacent to the third portion and constitutes the inside portion of the frame in plane with the filter medium panel in assembled mode.

The score and fold line between the first and the second portion of the second frame leg is denoted as 603. The first and second leg portions are folded perpendicular to each other or at an obtuse angle in assembled mode. The score and fold line between the second and the third portion of the second frame leg is denoted as 605. The third leg portion is completely folded back to the inside of the filter frame onto the second leg portion to form an integral outside edge of the filter frame perpendicular or at an obtuse angle to the plane of the filter medium panel and the first and forth leg portion of the frame. The score and fold line between the third and the forth portion of the second frame leg is denoted as 607. The forth leg portion is folded perpendicular or at an obtuse angle to the third leg portion, so that it is essentially parallel to the first frame leg portion and clampingly engages the filter medium panel therewith.

The first frame leg is provided with a tab at its third portion towards the corner, 512. This tab will slide between the second and third portion of the second leg during frame assembly. Preferably, this tab is straight. Alternatively, this tab may be at an angle to the first frame leg.

At its end towards the corner, the outside, forth portion of the first frame leg has a very small tab, 510. During frame assembly, this tab is inserted in a corresponding small slit, 610, provided at the score line 603 of the second frame leg.

The assembly process of the second preferred embodiment of the invention is the same as the process for the first preferred embodiment of the invention, as described in FIG. 2.

Certain modifications and improvements will occur to those skilled in the art upon a reading of the foregoing description. By way of example the frame may have three sides to form a triangular frame, or it may have more than four sides to form a polygon (having N sides). All modifications and improvements have been deleted herein for the sake of conciseness and readability but are properly within the scope of the following claims.

What is claimed is:

1. A foldable filter frame made from one piece of material having multiple corners, each corner comprising:
a. first and second frame legs, each frame leg comprising a first, second, third, and fourth foldable portion;
b. a first tab connected to the first frame leg, the first tab having dimensions such that, when the frame is folded, the first tab inserts between the folded portions of the second frame leg;
c. a second tab connected to the second frame leg;
d. a tab opening in the first frame leg corresponding in size to the second tab; and
e. wherein the first and second frame legs are connected to each other at an interior angle of less than approximately 180 degrees.

2. The foldable filter frame according to claim 1, wherein the first tab is connected to the first frame leg at an angle of approximately 90 degrees.

3. The foldable filter frame according to claim 1, wherein the first tab is connected to the first frame leg at an angle of less than approximately 90 degrees.

4. The foldable filter frame according to claim 1, further comprising a filter media plane wherein, when folded, the first and second frame legs are at an angle of approximately 90 degrees to the filter media plane.

5. The foldable filter frame according to claim 1, further comprising a filter media plane wherein, when folded, the first and second frame legs are at an obtuse interior angle to the filter media plane.

6. The foldable filter frame according to claim 1, further comprising scored folding lines between each foldable portion of the first and second frame legs.

7. The foldable filter frame according to claim 1, wherein the frame material is cardboard.

8. The foldable filter frame according to claim 1, wherein the second tab inserts into the tab opening in a locked position when the frame is folded into an assembled position.

9. The foldable filter frame according to claim 8, wherein the frame is releasably held in an assembled position when the second tab is in the locked position.

10. The foldable filter frame according to claim 8, wherein the second tab is press fit in the tab opening when in the locked position.

11. The foldable filter frame according to claim 8, wherein, the first tab has dimensions such that, when folded, the first tab inserts between the folded portions of the second frame leg in a held position such that the first leg is prevented from pivoting away from the second leg.

12. The foldable filter frame according to claim 1, further comprising a third tab connected to the first frame leg and a corresponding tab slit located in the second frame leg.

13. The foldable filter frame according to claim 12, wherein the third tab inserts into the tab slit when the frame is folded.

14. The foldable filter frame according to claim 13, wherein the second tab inserts into the tab opening in a locked position when the frame is folded into an assembled position.

15. The foldable filter frame according to claim 13, wherein the frame is releasably held in an assembled position when the second tab is in the locked position.

16. The foldable filter frame according to claim 13, wherein the second tab is press fit in the tab opening when in the locked position.

17. The foldable filter frame according to claim 13, wherein, the first tab has dimensions such that, when folded, the first tab inserts between the folded portions of the second frame leg in a held position such that the first leg is prevented from pivoting away from the second leg.

18. A method of making a filter frame comprising the following steps:
a. providing a filter frame as described in claim 1;
b. folding the third and forth portions of the first frame leg onto the first and second portions of the first frame leg;
c. folding the second and third portions of the first leg to form an angle of at least about 90 degrees with respect to the first and fourth portions of the first leg;
d. folding the first tab to form an angle of at least about 90 degrees with respect to the first frame leg;
e. folding the second, third, and forth leg portions of the second frame leg to form an angle of at least about 90 degrees with respect to the second frame leg;
f. folding the third leg portion of the second frame leg back onto the second portion of the second frame leg;
g. folding the forth portion of the second frame leg back onto the first portion of the second frame leg; and
h. forcing the second tab into the tab opening, releasably locking the frame in a folded position.

19. The method of folding a foldable filter frame according to claim 18 further comprising the following steps:
a. folding the foldable filter frame around a filter media; and
b. sealing the folded filter frame with an adhesive after the frame is locked in a folded position.

20. A method of folding a foldable filter frame comprising the following steps:
a. providing a filter frame as described in claim 12;
b. folding the third and forth portions of the first frame leg onto the first and second portions of the first frame leg;
c. inserting the third tab into the tab slit.
d. folding the second and third portions of the first leg to form an angle of at least about 90 degrees with respect to the first and fourth portions of the first leg;
e. folding the first tab to form an angle of at least about 90 degrees with respect to the first frame leg;
f. folding the second, third, and forth leg portions of the second frame leg to form an angle of at least about 90 degrees with respect to the second frame leg;
g. folding the third leg portion of the second frame leg back onto the second portion of the second frame leg;
h. folding the forth portion of the second frame leg back onto the first portion of the second frame leg; and
i. forcing the second tab into the tab opening, releasably locking the frame in a folded position.

21. The method of folding a foldable filter frame according to claim 20 further comprising the following steps:
a. folding the foldable filter frame around a filter media; and
b. sealing the folded filter frame with an adhesive after the frame is locked in a folded position.
